(19) United States
(12) Patent Application Publication
(10) Pub. No.: US 2008/0106646 A1
(43) Pub. Date: May 8, 2008

(54) SYSTEM, APPARATUS, METHOD, AND COMPUTER PROGRAM PRODUCT FOR GENERATING AN ON-SCREEN DISPLAY

(75) Inventor: Hsin-Ming LEE, Taipei City (TW)

Correspondence Address: NIXON PEABODY LLP - PATENT GROUP, 1100 CLINTON SQUARE, ROCHESTER, NY, 14604, US

(73) Assignee: Media Tek Inc., Hsin-Chu City (TW)

(21) Appl. No.: 11/556,888

(22) Filed: Nov. 6, 2006

(51) Int. Cl. H04N 5/50; H04N 5/00

(52) U.S. Cl. 348/569; 386/126; 348/E05.097

(57) ABSTRACT

Video processing systems, apparatuses, methods, and computer program products for generating an OSD according to an OSD data set and a plurality of available colors are provided. The video processing apparatus comprises a control unit and a memory. The control unit is configured to determine whether the OSD data set comprises number information and if so, to determine whether to update colors according to color information and the number information. The first memory is configured to store the updated colors if the colors are updated. The number information indicates the number of colors required to generate the OSD. By using the present invention, memory space for storing OSD data sets is greatly saved.

### CROSS-REFERENCES TO RELATED APPLICATIONS

No applicable.

### BACKGROUND OF THE INVENTION

1. Field of the Invention

The present invention relates to systems, apparatuses, methods, and computer program products for generating an On-Screen Display (OSD); more particularly, relates to systems, apparatuses, methods, and computer program products for generating an OSD according to an OSD data set and a plurality of available colors.

2. Descriptions of the Related Art

Due to the rapid development of video technologies, multimedia appliances in the current market are capable of providing more and more fancy functions. An OSD is one of the many examples. An OSD is an image superimposed on a screen picture to display information such as control panel, volume, channel, time, or the like to users. Its appearance allows easier control over the multimedia system.

Generally speaking, the display information of an OSD coming from an OSD data set is stored in a memory. If a set of 60 OSD pictures reveals a complete piece of display information, the memory stores 60 OSD data sets for the 60 OSD pictures, respectively. FIG. 1 shows two of the OSD data sets 11, 13, for example. The OSD data set 11 comprises a header 111, a color palette 113, and a pixel data 115, while the OSD data set 13 comprises a header 131, a color palette 133, and a pixel data 135. The headers 111, 131 include information and formats of the corresponding OSD pictures. The color palettes 113, 133 comprise color information used in the corresponding OSD pictures. The pixel data 115, 135 include pixel information specifying which color to use. It is obvious that the more colors recorded in the color palettes 113, 133, the more memory space is required. As a result, cost and processing time are increased.

In U.S. Pat. No. 6,570,626, a modified OSD format that saves memory bandwidth is provided. A header of an OSD data set comprises one control bit to indicate whether the OSD data set includes a color palette. An OSD data set without a color palette occupies less memory space. In such a circumstance, a color palette included in a previous OSD data set is used instead to perform the desired colors. However, if most of the OSD data sets comprise a color palette, it still requires large memory space.

Therefore, a solution that can save memory space while displaying an OSD in a multimedia system is still in high demand.

### SUMMARY OF THE INVENTION

An object of this invention is to provide a video processing apparatus for generating an OSD according to an OSD data set and a plurality of available colors. The video processing apparatus comprises a control unit and a memory. The control unit is configured to determine whether the OSD data set comprises number information and if yes, to determine whether to update colors according to color information and the number information. The memory is configured to store the updated colors if the colors are updated. The number information indicates the number of the colors in the available colors required to be updated to generate the OSD.

Another object of this invention is to provide a video processing method for generating an OSD according to an OSD data set and a plurality of available colors. The video processing method comprises the steps of determining whether the OSD data set comprises number information; determining whether to update colors according to color information and the number information if the OSD data set is determined to comprise the number information; and storing the updated colors if the colors are updated. The number information indicates the number of the colors in the available colors required to be updated to generate the OSD.

Another object of this invention is to provide a video processing apparatus for generating an OSD according to an OSD data set and a plurality of available colors. The video processing apparatus comprises means for determining whether the OSD data set comprises number information and if yes, for determining whether to update colors according to color information and the number information; and means for storing the updated colors if the colors are updated. The number information indicates the number of the colors in the available colors required to be updated to generate the OSD.

Yet another object of this invention is to provide a computer program product for storing a computer program to execute a video processing method for generating an OSD according to an OSD data set and a plurality of available colors. The computer program comprises code for determining whether the OSD data set comprises number information; code for determining whether to update colors according to color information and the number information if the OSD data set is determined to comprise the number information; and code for storing the updated colors if the colors are updated. The number information indicates the number of the colors in the available colors required to be updated to generate the OSD.

Yet another object of this invention is to provide a DVD system for simultaneously displaying an image and an OSD. The OSD is generated according to an OSD data set and a plurality of available colors. The DVD system comprises an image processing unit, an OSD processing unit, and a mixer. The image processing unit is configured to generate the image. The OSD processing unit is configured to determine whether the OSD data set comprises number information, to determine whether to update colors according to color information and the number information if yes, and to generate the OSD according to the updated colors. The mixer is configured to mix the image and the OSD. The number information indicates the number of colors in the available colors required to be updated to generate the OSD.

Yet another object of this invention is to provide a TV system for simultaneously displaying an image and an OSD. The OSD is generated according to an OSD data set and a plurality of available colors. The TV system comprises an image processing unit, an OSD processing unit, and a mixer. The image processing unit is configured to generate the image. The OSD processing unit is configured to determine whether the OSD data set comprises number information, to determine whether to update colors according to color information and the number information if yes, and to generate the OSD according to the updated colors. The mixer is configured to mix the image and the OSD. The number information indicates the number of colors in the available colors required to be updated to generate the OSD.

A further object of this invention is to provide a display system for simultaneously displaying an image and an OSD. The OSD is generated according to an OSD data set and a plurality of available colors. The display system comprises an image processing unit, an OSD processing unit, and a mixer. The image processing unit is configured to generate the image. The OSD processing unit is configured to determine whether the OSD data set comprises number information, to determine whether to update colors according to color information and the number information if yes, and to generate the OSD according to the updated colors. The mixer is configured to mix the image and the OSD. The number information indicates the number of colors in the available colors required to be updated to generate the OSD.

By introducing number information in an OSD data set, the OSD data set in accordance with the present invention is able to indicate whether to update colors. If so, the color palette carries only the colors required for an update, and not all of the available colors. As a result, memory space for storing OSD data sets is greatly saved.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a format of an OSD data set of the prior art;

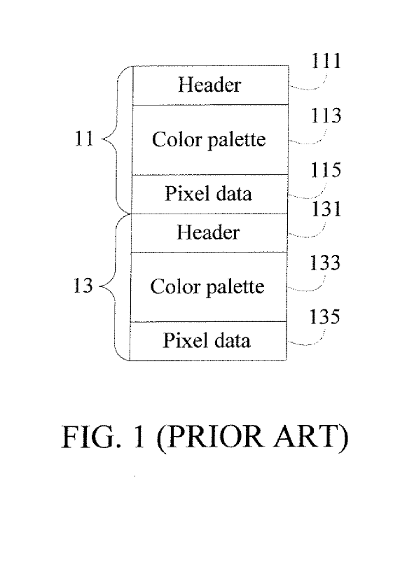

FIG. 2 illustrates a first embodiment of the present invention; and

FIG. 3 illustrates a second embodiment of the present invention.

### DESCRIPTION OF THE PREFERRED EMBODIMENT

The present invention provides video processing systems, apparatuses, methods, and computer program products for forming colors of an OSD according to number information of the colors required for updating an OSD data set. As a result, the size of the OSD data set is smaller than that of the prior art.

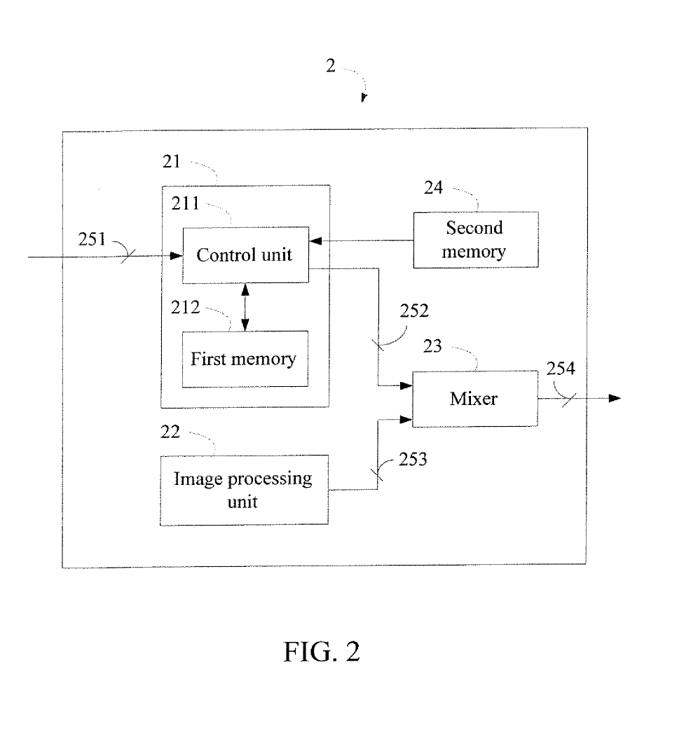

FIG. 2 illustrates a first embodiment of this invention, which is a DVD system 2 for simultaneously displaying an image and an OSD which is superimposed on the image. The DVD system 2 comprises an OSD processing unit 21, an image processing unit 22, a mixer 23, and a second memory 24. The OSD processing unit 21 comprises a control unit 211 and a first memory 212.

The control unit 211 receives an OSD data set 251 and determines whether a header of the OSD data set 251 comprises a plurality of bits that carry number information. The number information indicates the number of colors required for update during OSD processing, in terms of the current available colors stored in the first memory 212. If the plurality of bits do not exist, the control unit 211 processes the OSD data set 251 in the old fashion manner. Otherwise, the control unit 211 further determines whether to update any of the available colors stored in the first memory 212. In the first embodiment, if the plurality of bits are not all zero, the control unit 211 determines that there is at least one color required for update. Furthermore, it means that the OSD data set 251 comprises a color palette that stores color information which defines the colors required for update. Then, the control unit 211 retrieves the color information from the color palette to update the colors and updates the colors to the first memory 212. In some preferred embodiments, the color palette stores an address pointing to the color information pre-stored in the second memory 24. The control unit 211 retrieves the color information from the second memory 24 according to the address and updates the first memory 212. If the plurality of bits are all zero, the control unit 211 determines not to update the colors.

In some preferred embodiments, the control unit 211 uses the following approach to determine whether to update colors. If the plurality of bits are null, the control unit 211 determines not to update colors. If the plurality of bits are not null, the control unit 211 determines to update colors. The term “null” is a special electrical condition to signify that the bits intentionally do not have meaning. For example, no voltage level is one kind of null.

After the control unit 211 updates colors or determines not to update colors, it generates an OSD 252 based on the available colors stored in the first memory 212. The image processing unit 22 generates an image 253. The mixer 23 mixes the OSD 252 and the image 253 and generates a superimposed picture 254. The superimposed picture 254 is then displayed onto a screen.

Those skilled in the art can easily apply the present invention to TV systems, digital systems, or the like with reference to the descriptions of the first embodiment.

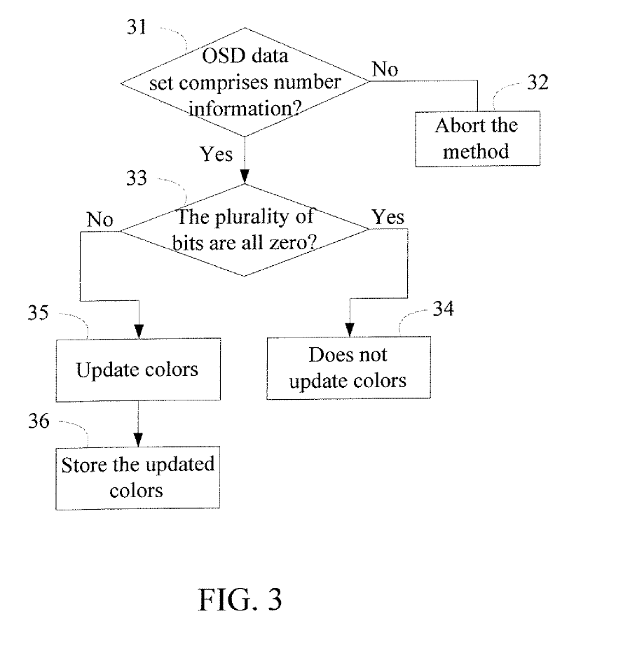

FIG. 3 illustrates a second embodiment of the present invention, which is a video processing method for generating an OSD according to an OSD data set and a plurality of available colors. The video processing method is adapted for a digital system or a multimedia system, such as a DVD system or a TV system. First, step 31 is executed to determine whether the OSD data set comprises a plurality of bits with number information. If not, step 32 is executed to abort the method. If so, step 33 is executed to determine whether the plurality of bits are all zero. If the bits are all zero, step 34 is executed, in which the available colors are not updated. If the bits are not all zero, step 35 is executed to update at least one of the available colors. The colors are updated according to the color information, which can be stored in the color palette of the OSD data set or pre-stored in the memory. Finally, step 36 is executed to store the updated colors. In addition to the steps shown in FIG. 3, the second embodiment is capable of performing all the operations or functions recited in the first embodiment. Those skilled in the art can straightforwardly realize how the second embodiment performs these operations and functions based on the above descriptions of the first embodiment. Therefore, the descriptions for these operations and functions are redundant and not repeated herein.

The method of the second embodiment may be executed by using a computer program product, which stores a computer program. The computer program comprises code to execute the steps. The computer program product can be a floppy disk, a hard disk, an optical disc, a flash disk, a tape, a network accessible database or a storage medium with the same functionality, which can be easily thought by people skilled in the field.

By introducing number information in an OSD data set, the OSD data set in accordance with the present invention, is able to indicate whether to update colors. If so, the color palette only carries colors required for update. Thus, the memory space for storing OSD data sets is greatly saved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A video processing apparatus for generating an on-screen display (OSD) according to an OSD data set and a plurality of available colors, the video processing apparatus comprising:
a control unit for determining whether the OSD data set comprises number information and if yes, for determining whether to update colors according to color information and the number information; and
a first memory for storing the updated colors if the color are updated;
wherein the number information indicates the number of the colors in the available colors required to be updated to generate the OSD.

2. The video processing apparatus of claim 1, wherein the OSD data set comprises a header for storing the number information.

3. The video processing apparatus of claim 1, wherein the number information is carried by a plurality of bits.

4. The video processing apparatus of claim 3, wherein if the plurality of bits are all zero, the control unit determines not to update colors.

5. The video processing apparatus of claim 3, wherein if the plurality of bits are not null, the control unit determines to update at least one color.

6. The video processing apparatus of claim 3, wherein if the plurality of bits are null, the control unit determines not to update colors.

7. The video processing apparatus of claim 1, wherein the OSD data set comprises a color palette to store the color information.

8. The video processing apparatus of claim 1, wherein the color information is retrieved from a second memory.

9. A video processing method for generating an on-screen display (OSD) according to an OSD data set and a plurality of available colors, the video processing method comprising the steps of:
determining whether the OSD data set comprises number information;
determining whether to update colors according to color information and the number information if the OSD data set is determined to comprise the number information; and
storing the updated colors if the colors are updated;
wherein the number information indicates the number of the colors in the available colors required to be updated to generate the OSD.

10. The video processing method of claim 9, wherein the OSD data set comprises a header for storing the number information.

11. The video processing method of claim 9, wherein the number information is carried by a plurality of bits.

12. The video processing method of claim 11, wherein the step of determining whether to update colors comprises the step of determining whether the plurality of bits are all zero, and the colors are not updated if the plurality of bits are determined all zero.

13. The video processing method of claim 11, wherein the step of determining whether to update colors comprises the step of determining whether the plurality of bits are not null, and the method further comprises the step of updating at least one color if the plurality of bits are determined not null.

14. The video processing method of claim 11, wherein the step of determining whether to update colors comprises the step of determining whether the plurality of bits are null, and the colors are not updated if the plurality of bits are null.

15. The video processing method of claim 9, wherein the OSD data set comprises a color palette to store the color information.

16. The video processing method of claim 9, wherein the color information is retrieved from a memory.

17. A video processing apparatus for generating an on-screen display (OSD) according to an OSD data set and a plurality of available colors, the video processing apparatus comprising:
means for determining whether the OSD data set comprises number information and if yes, for determining whether to update colors according to color information and the number information; and
means for storing the updated colors if the colors are updated;
wherein the number information indicates the number of the colors in the available colors required to be updated to generate the OSD.

18. The video processing apparatus of claim 17, wherein the OSD data set comprises a header for storing the number information.

19. The video processing apparatus of claim 17, wherein the number information is carried by a plurality of bits.

20. The video processing apparatus of claim 19, wherein if the plurality of bits are all zero, the determining means determines not to update colors.

21. The video processing apparatus of claim 19, wherein if the plurality of bits are not null, the determining means determines to update at least one color.

22. The video processing apparatus of claim 19, wherein if the plurality of bits are null, the determining means determines not to update colors.

23. The video processing apparatus of claim 17, wherein the OSD data set comprises a color palette to store the color information.

24. The video processing apparatus of claim 17, wherein the color information is retrieved from a memory.

25. A computer program product for storing a computer program to execute a video processing method for generating an on-screen display (OSD) according to an OSD data set and a plurality of available colors, the computer program comprising:
code for determining whether the OSD data set comprises number information;
code for determining whether to update colors according to color information and the number information if the OSD data set is determined to comprise the number information; and
code for storing the updated colors if the colors are updated;
wherein the number information indicates the number of the colors in the available colors required to be updated to generate the OSD.

26. The computer program product of claim 25, wherein the OSD data set comprises a header for storing the number information.

27. The computer program product of claim 25, wherein the number information is carried by a plurality of bits.

28. The computer program product of claim 27, wherein the code for determining whether to update colors comprises code for determining whether the plurality of bits are all zero, and the colors are not updated if the plurality of bits are determined all zero.

29. The computer program product of claim 27, wherein the code for determining whether to update colors comprises code for determining whether the plurality of bits are not null, and the computer program further comprises code for updating at least one color if the plurality of bits are determined not null.

30. The computer program product of claim 27, wherein the code for determining whether to update colors comprises code for determining whether the plurality of bits are null, and the colors are not updated if the plurality of bits are null.

31. The computer program product of claim 25, wherein the OSD data set comprises a color palette to store the color information.

32. The computer program product of claim 25, wherein the color information is retrieved from a memory.

33. A DVD system for simultaneously displaying an image and an on-screen display (OSD), the OSD being generated according to an OSD data set and a plurality of available colors, comprising:
an image processing unit for generating the image;
an OSD processing unit for determining whether the OSD data set comprises number information, for determining whether to update colors according to color information and the number information if yes, and for generating the OSD according to the updated colors; and
a mixer for mixing the image and the OSD;
wherein the number information indicates the number of colors in the available colors required to be updated to generate the OSD.

34. A TV system for simultaneously displaying an image and an on-screen display (OSD), the OSD being generated according to an OSD data set and a plurality of available colors, comprising:
an image processing unit for generating the image;
an OSD processing unit for determining whether the OSD data set comprises number information, for determining whether to update colors according to color information and the number information if yes, and for generating the OSD according to the updated colors; and
a mixer for mixing the image and the OSD;
wherein the number information indicates the number of colors in the available colors required to be updated to generate the OSD.

35. A display system for simultaneously displaying an image and an on-screen display (OSD), the OSD being generated according to an OSD data set and a plurality of available colors, comprising:
an image processing unit for generating the image;
an OSD processing unit for determining whether the OSD data set comprises number information, for determining whether to update colors according to color information and the number information if yes, and for generating the OSD according to the updated colors; and
a mixer for mixing the image and the OSD;
wherein the number information indicates the number of colors in the available colors required to be updated to generate the OSD.
